(19) United States
(12) Patent Application Publication
(10) Pub. No.: US 2022/0332567 A1
(43) Pub. Date: Oct. 20, 2022

(54) THREE-DIMENSIONAL DOWN REPLACEMENT

(71) Applicant: The North Face Apparel Corp., Wilmington, DE (US)

(72) Inventors: Cory Michael Olson, Golden, CO (US); Jeffrey Allen Dorton, Dublin, CA (US)

(21) Appl. No.: 17/642,409

(22) PCT Filed: Sep. 11, 2020
(86) PCT No.: PCT/US2020/050298

§ 371 Date: Mar. 11, 2022

Related U.S. Application Data
(60) Provisional application No. 62/899,969, filed on Sep. 13, 2019.

(51) Int. Cl. B68G 11/04; A41G 11/02

(52) U.S. Cl. CPC B68G 11/04; A41G 11/02; B33Y 80/00

(57) ABSTRACT

Articles (100, 200, 300, 400) are described herein. An example article may comprise a first surface (404) comprising a first lattice. The example article may comprise a second surface (406) at least partially spaced from the first surface (404) and having at least one common terminal connection point with the first surface (404). The first surface (404) may comprise a second lattice. The first surface (404) and the second surface (406) may define a cavity (407) therebetween. The first surface (404) and the second surface (406) may be capable of being deformed from a first state to a second state under a compression force to constrict a volume of the cavity. The first surface (404) and the second surface (406) may be capable of returning to the first state when the compression force is released.

### BACKGROUND

Clothes, such as jackets, and other items, such as blankets, may need insulation. Animal feathers (e.g., down) may be used as the insulation. However, a sustainable form of insulation that can replace animal derived insulation is needed. Some synthetic down replacement is known. But, synthetic downs may not perform as well as conventional down. Thus, improvements are needed.

### SUMMARY

Insulative baffles are described herein. An example insulative baffle may comprise a first surface comprising by a plurality of first interconnected struts that define a plurality of first apertures through the first surface. The example insulative baffle may comprise a second surface at least partially spaced from the first surface and having at least one common terminal connection point with the first surface. The first surface may comprise a plurality of second interconnected struts that define a plurality of second apertures through the second surface. The example insulative baffle may comprise one or more third struts disposed between the first surface and the second surface and coupled to at least one of the first surface and the second surface. The first surface and the second surface may define a cavity therebetween. The one or more third struts may be disposed within or adjacent the cavity. The first surface and the second surface may be capable of being deformed from a first state to a second state under a compression force to constrict a volume of the cavity. The first surface and the second surface may be capable of returning to the first state when the compression force is released.

Articles are described herein. An example article may comprise a first surface comprising a first lattice. The example article may comprise a second surface at least partially spaced from the first surface and having at least one common terminal connection point with the first surface. The first surface may comprise a second lattice. The first surface and the second surface may define a cavity therebetween. The first surface and the second surface may be capable of being deformed from a first state to a second state under a compression force to constrict a volume of the cavity. The first surface and the second surface may be capable of returning to the first state when the compression force is released.

### BRIEF DESCRIPTION OF THE DRAWINGS

The following drawings show generally, by way of example, but not by way of limitation, various examples discussed in the present disclosure. In the drawings:

FIG. 1 is a perspective view of an article comprising three baffles in accordance with the present disclosure.

FIG. 2 illustrates an enlarge view of a portion of FIG. 1.

FIG. 3 illustrates a top perspective view of an example insulative baffle in accordance with the present disclosure.

FIG. 4 is a side perspective view of a portion of an example insulative baffle in accordance with the present disclosure.

FIG. 5 is a side perspective view of a portion of an example insulative baffle in accordance with the present disclosure.

FIG. 6 illustrates an example insulative baffle.

### DETAILED DESCRIPTION

Described herein are three-dimensionally (3D) printed structures to replace conventional insulation. Reference is made to down, such as goose down, but it should be understood that other insulative materials (e.g., synthetics) conventionally used in apparel may also be replaced or supplemented.

Described herein are systems, methods, articles, and/or insulative baffles to create a more sustainable solution than an animal derived product. Described herein are systems, methods, article, and/or insulative baffles that may out perform any synthetic insulation currently on the market. Conventional synthetic insulation is limited to cut staple and continuous filament constructions that are modified in different ways. The systems, methods, article, and/or insulative baffles described herein may use different substrates and different structures to achieve the purpose of trapping air (insulation). The 3D printed structures may comprise an initial state. The 3D printed structures may be compressed. During compression, the 3D printed structures may comprise a state different from the initial state. The 3D printed structures may return to the initial state after compression. The systems, methods, article, and/or insulative baffles described herein may allow quick and efficient loft of a baffle structure that encapsulates a synthetic fill on a garment.

As described herein, air permeability may be tested using ASTM D737; hardness may be tested using ASTM D2240; and flex properties (3 point bend) may be tested using ASTM D790. Various articles or sample sizes may be tested. Other parameters and standards may be used.

Insulative baffles are described herein. An example insulative baffle may comprise a first surface comprising by a plurality of first interconnected struts that define a plurality of first apertures through the first surface. The first surface may comprise a curvilinear shape. The plurality of first interconnected struts may define a lattice structure. The first surface may be at least partially formed using additive manufacturing.

The example insulative baffle may comprise a second surface at least partially spaced from the first surface and having at least one common terminal connection point with the first surface. The first surface may comprise a plurality of second interconnected struts that define a plurality of second apertures through the second surface. The second surface may comprise a curvilinear shape. The plurality of second interconnected struts may define a lattice structure. The second surface may be at least partially formed using additive manufacturing.

The example insulative baffle may comprise one or more third struts disposed between the first surface and the second surface and coupled to at least one of the first surface and the second surface. The first surface and the second surface may define a cavity therebetween. The one or more third struts may be disposed within or adjacent the cavity. The first surface and the second surface may be capable of being deformed from a first state to a second state under a compression force to constrict a volume of the cavity. The first surface and the second surface may be capable of returning to the first state when the compression force is released.

The example insulative baffle may comprise a generally half-column shape. A plurality of the third struts may define a lattice structure. The example insulative baffle may comprise a first layer disposed to cover at least a portion of the first surface. The example insulative baffle may comprise a second layer disposed to cover at least a portion of the second surface. A configuration of the first interconnected struts, the second interconnect struts, and the third struts may be tunable to control a rigidity of the example insulative baffle.

Articles are described herein. An example article may comprise a first surface comprising a first lattice. The first surface may comprise a curvilinear shape. The first surface may be at least partially formed using additive manufacturing.

The example article may comprise a second surface at least partially spaced from the first surface and having at least one common terminal connection point with the first surface. The first surface may comprise a second lattice. The second surface may comprise a curvilinear shape. The second surface may be at least partially formed using additive manufacturing.

The first surface and the second surface may define a cavity therebetween. The first surface and the second surface may be capable of being deformed from a first state to a second state under a compression force to constrict a volume of the cavity. The first surface and the second surface may be capable of returning to the first state when the compression force is released.

The example article may comprise a generally half-column shape. The example article may comprise a generally rectangular cross-section. Various shapes and sizes may be used. The example article may comprise a first layer disposed to cover at least a portion of the first surface. The example article may comprise a second layer disposed to cover at least a portion of the second surface. A configuration of the first lattice and the second lattice may be tunable to control a rigidity of the example article.

FIG. 1 illustrates an example article 100. The article 100 may form part of an item such as a garment, a blanket a back or body brace, backpack or bag. As shown, the article 100 comprises three baffles structures or baffles 102. Any number of baffles 102 may be used. The baffles 102 may have various shapes and sizes. The baffles 102 may be formed using various processes such as additive manufacturing. As show, the baffles may comprise a lattice structure having a plurality of interconnecting struts. A material may be disposed around the baffles 102. As such, the lattice structure may allow air to be trapped in the baffles 102 within the material in order to provide increased insulation. The lattice structure may be compressible and may be configured to return to a uncompressed form.

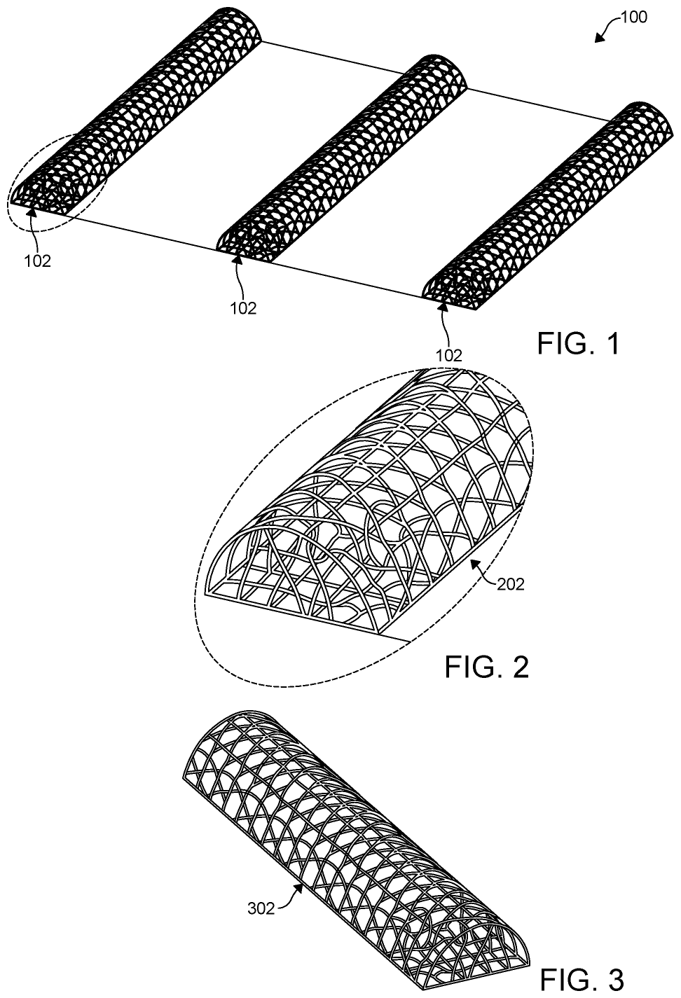

FIG. 2 illustrates an enlarged baffle 2020 of the insulative baffle structure 102 shown in FIG. 1. Various designs may be modeled and then formed based on the model or other means. The baffle structure 202 may be configured to define a number of apertures or lattice configurations to effect a desired insulative value and/or stiffness. The baffle structure 202 may be covered with one or more materials to facilitate insulation. The baffle structure 202 and the cover materials may be configured for particular purposes such as particular garments.

FIG. 3 shows an example baffle structure 302 manufactured using an additive manufacturing process. The baffle structure 302 may be similar to the baffle 102. Various designs may be modeled and then formed based on the model or other means. The baffle structure 202 may be configured to define a number of apertures or lattice configurations to effect a desired insulative value and/or stiffness. The baffle structure 302 may be covered with one or more materials to facilitate insulation. The baffle structure 302 and the cover materials may be configured for particular purposes such as particular garments.

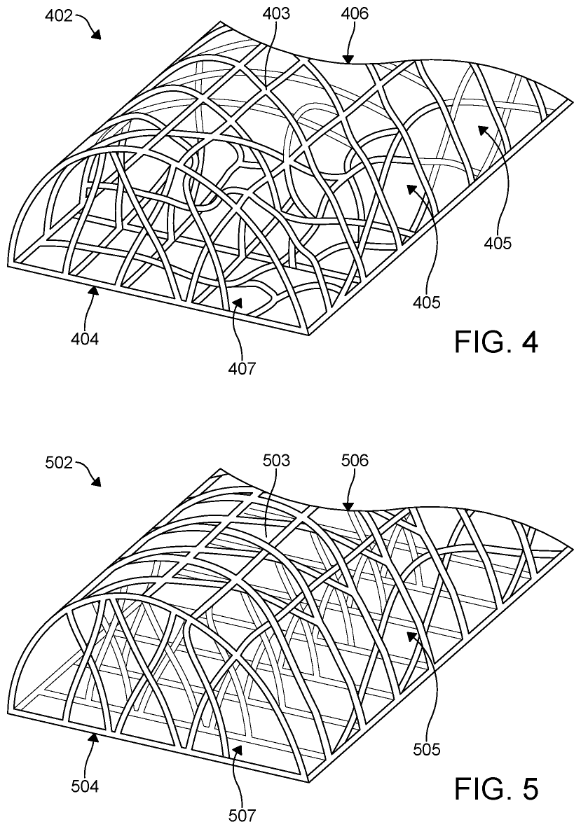

FIG. 4 illustrates a portion of an example insulative baffle 402. The baffle 402 may comprise a first surface 404 and a second surface 406 at least partially spaced from the first surface 404. The first surface 404 and the second surface 406 may have at least one common terminal point between them. As an example, the first surface 404 may extend and join at least a portion of the second surface 406. As shown, the first surface 404 is a rectangular, planar surface and the second surface 406 is a semi-circular curvilinear surface. Other shapes and sizes may be used. The first surface 404 and the second surface 406 may define a cavity 407. The first surface 404 and the second surface 406 may be at least partially formed using additive manufacturing. The first surface 404 and the second surface 406 may comprise a plurality of interconnected struts 403 that define a plurality of apertures 405 through the first surface 404 and the second surface 406. The plurality of interconnected struts 403 may comprise one or more lattice structures. One or more additional struts or lattice structures may be coupled to the first surface 404, the second surface 406 or to both surfaces 404, 406. A configuration of the interconnected struts 403 may be tunable to control a rigidity of the baffle 402. At least a portion of the first surface 404 or the second surface 406 may be covered by one or more layers. The layers may comprise fabric or other materials. Various material layers may be used. As an example, the material layers may be different from conventional down-proof layers since the baffle structure provides insulation without conventional down.

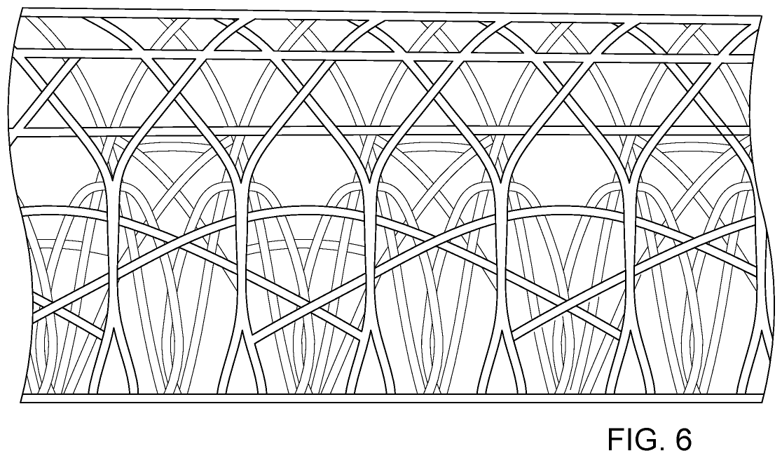

FIG. 5 illustrates a portion of an example insulative baffle 502. The baffle 502 may comprise a first surface 504 and a second surface 506 at least partially spaced from the first surface 504. The first surface 504 and the second surface 506 may have at least one common terminal point between them. As shown, the first surface 504 is a rectangular, planar surface and the second surface 506, is a semi-circular planar surface. The first surface 504 and the second surface 506 may define a cavity 507. The first surface 504 and the second surface 506 may be at least partially formed using additive manufacturing. The first surface 504 and the second surface 506 may comprise a plurality of interconnected struts 503 that define a plurality of apertures 505 through the first surface 504 and the second surface 506. The plurality of interconnected struts 503 may comprise one or more lattice structures. One or more additional struts or lattice structures may be coupled to the first surface 504, the second surface 506 or to both surfaces 504, 506. A configuration of the interconnected struts 503 may be tunable to control a rigidity of the baffle 502. At least a portion of the first surface 504 or the second surface 506 may be covered by one or more layers. As an example, the material layers may be different from conventional down-proof layers since the baffle structure provides insulation without conventional down (other insulative materials. Various strut shapes, sizes, and patterns may be used, as illustrated for example in FIG. 6.

What is claimed is:

1. An insulative baffle comprising:
a first surface comprising by a plurality of first interconnected struts that define a plurality of first apertures through the first surface;
a second surface at least partially spaced from the first surface and having at least one common terminal connection point with the first surface, the first surface comprising a plurality of second interconnected struts that define a plurality of second apertures through the second surface; and
one or more third struts disposed between the first surface and the second surface and coupled to at least one of the first surface and the second surface,
wherein the first surface and the second surface define a cavity therebetween,
wherein the one or more third struts are disposed within or adjacent the cavity, and
wherein the first surface and the second surface are capable of being deformed from a first state to a second state under a compression force to constrict a volume of the cavity and wherein the first surface and the second surface are capable of returning to the first state when the compression force is released.

2. The insulative baffle of claim 1, wherein the first surface has a curvilinear shape.

3. The insulative baffle of any one of claims 1-2, wherein the second surface has a curvilinear shape.

4. The insulative baffle of any one of claims 1-3, wherein the insulative baffle has a generally half-column shape.

5. The insulative baffle of any one of claims 1-4, wherein the plurality of first interconnected struts define a lattice structure.

6. The insulative baffle of any one of claims 1-5, wherein the plurality of second interconnected struts define a lattice structure.

7. The insulative baffle of any one of claims 1-6, wherein a plurality of the third struts define a lattice structure.

8. The insulative baffle of any one of claims 1-7, wherein one or more of the first surface or the second surface is at least partially formed using additive manufacturing.

9. The insulative baffle of any one of claims 1-8, further comprising a first layer disposed to cover at least a portion of the first surface.

10. The insulative baffle of any one of claims 1-9, further comprising a second layer disposed to cover at least a portion of the second surface.

11. The insulative baffle of any one of claims 1-10, wherein a configuration of the first interconnected struts, the second interconnect struts, and the third struts are tunable to control a rigidity of the insulative baffle.

12. A method of making the article of any one of claims 1-11.

13. An article comprising:
a first surface comprising a first lattice; and
a second surface at least partially spaced from the first surface and having at least one common terminal connection point with the first surface, the first surface comprising a second lattice;
wherein the first surface and the second surface define a cavity therebetween, and
wherein the first surface and the second surface are capable of being deformed from a first state to a second state under a compression force to constrict a volume of the cavity and wherein the first surface and the second surface are capable of returning to the first state when the compression force is released.
